(19) United States
(12) Patent Application Publication
(10) Pub. No.: US 2006/0266800 A1
(43) Pub. Date: Nov. 30, 2006

(54) COPPER WELDING SOLID WIRE WITH GOOD ARC STABILITY

(76) Inventor: Hu Geun HWANG, Changwon (KR)

Correspondence Address: SQUIRE, SANDERS & DEMPSEY L.L.P, 600 HANSEN WAY, PALO ALTO, CA, 94304-1043, US

(21) Appl. No.: 11/277,358

(22) Filed: Mar. 23, 2006

(30) Foreign Application Priority Data
May 25, 2005 (KR) 10-2005-0043934

(51) Int. Cl. A47J 36/02

(52) U.S. Cl. 228/101

(57) ABSTRACT

Disclosed is a copper plating solid wire for MAG welding with excellent arc stability during welding, in which the solid wire for MAG welding is manufactured by high-speed copper plating by being immersed in a copper plating solution to make a plating layer of 0.2-1.0 μm in thickness, and the plating layer comprises 100-1000 ppm of Fe, an alkali metal (Na), and alkaline earth metals (Mg, Ca) in total wherein the content of the alkali metal (Na) and the alkaline earth metals (Mg, Ca) ranges from 10 ppm to 500 ppm. According to the present invention, the copper plating solid wire for MAG welding with excellent feedability and arc stability during welding can be obtained despite the high-speed plating process.

### BACKGROUND OF THE INVENTION

1. Field of the Invention

The present invention relates to a copper welding solid wire, more specifically, to a copper welding solid wire with good arc stability.

2. Description of the Related Art

In general, regardless of the kind of wires, such as solid wire or flux cored wire, arc stability is a very important factor for arc welding from a view point of the quality of a welded bead or maintenance process due to the welding spatter, and many recognize that the arc stability is closely related to wire feedability.

Especially, a non-plated solid wire for welding has been recently released. As the name implies, the non-plated wire does not go through the plating process. In result, it comes into direct contact with the iron surface of wire and welding tip and therefore, problems such as excessive abrasion of tip, deterioration of arc stability, limitation in arc stability interval, etc., arise.

This is why more than 95% of MAG welding wires have copper plating.

However, most of researches for improving arc stability and feedability of welding materials have mainly focused on the surface pattern of wire or surfacing preparations, and researches on plating solution (bath) for copper plating were relatively low. In case of copper plating, batch type plating is widely used in many plating companies, and a variety of additives are available at a market.

However, as in the manufacturing process of a solid wire for welding, high-speed wire drawing with coating lubricant on the surface of wire and carrying out plating precipitation of excellent plating adhesion within 2 seconds by high speed in-line are very difficult jobs. Because of this, most of researches have been directed to resolve the problems of a wire with copper plating through wet drawing or surface treatment processes which are performed after the plating process.

For example, Japanese Patent Laid-open No. 56-144892 disclosed a technique related to a solid wire for welding with copper plating to improve feedability by forming layers oxidized with heat-treatment to make holes on the surface through wet drawing, and by providing liquid lubricant to these holes.

Another method for improving arc stability disclosed in Japanese Patent Laid-open NO. 6-218574 is coating the surface of wire with alkali metal oxide and performing annealing for precipitation. Then, the wire undergoes copper plating after pickled.

On the other hand, Japanese Patent Laid-open No. 7-299583 disclosed a technique for improving feedability and arc stability by adding K, Ca and their compounds to the surfacing preparation (surface treatment agent) for coating the surface of a final wire.

Moreover, Japanese Patent Laid-open No. 6-218574 disclosed a technique on conducting copper plating after citrate, halogen compounds, phosphate are applied to the surface of a wire, and next annealing is performed under nitrogen gas atmosphere to deposit alkali metals on the surface of the wire.

After studying these techniques carefully, the inventors decided to study an optimal plating solution composition and its managing method for continuous high-speed copper plating. As a result, we were able to manufacture a copper plating solid wire with excellent plating adhesion, and excellent arc stability by securing good wire feedability.

### SUMMARY OF THE INVENTION

It is, therefore, an object of the present invention to provide a copper plating solid wire characterized of excellent plating adhesion by using an inorganic additive in a copper plating solution and at the same time, of excellent feedability and arc stability by precipitating an alkali metal (Na) and alkaline earth metals (Mg, Ca) in the plating layer.

To achieve the above objects and advantages, there is provided a copper plating solid wire for MAG welding, in which a copper plating layer of 0.2-1.0 μm in thickness is formed on a solid wire for MAG welding composed of 0.01-0.10 wt % of C, 0.3-1.0 wt % of Si, 0.7-2.0 wt % of Mn, 0.001-0.030 wt % of P, 0.001-0.030 wt % of S, 0.01-0.50 wt % of Cu, the remainders Fe and inevitable impurities, the total content of Fe, an alkali metal (Na), and alkaline earth metals (Mg, Ca) in the copper plating layer ranges from 100 ppm to 1000 ppm, and the total content of the alkali metal (Na) and the alkaline earth metals (Mg, Ca) ranges from 10 ppm to 500 ppm at the same time.

Another aspect of the present invention provides a method for manufacturing a copper plating solid wire for MAG welding with excellent arc stability for welding, the method comprising the step of: immersing a solid wire for MAG welding composed of 0.01-0.10 wt % of C, 0.3-1.0 wt % of Si, 0.7-2.0 wt % of Mn, 0.001-0.030 wt % of P, 0.001-0.030 wt % of S, 0.01-0.50 wt % of Cu, the remainders Fe and inevitable impurities in a copper plating solution containing 200-300g/L of CuSO₄.5H₂O, 30-50g/L of H₂SO₄, 10-40 g/L of Fe, 1.0-10 g/L of Mg, 0.1-1.0 g/L of Na, 0.1-1.0g/L of Ca, 1.0-5.0g/L of Cl, and 0.01-0.1 g/L of EDTA at 30-50° C. for 1.5-2.5 seconds.

### BRIEF DESCRIPTION OF THE DRAWINGS

The above aspects and features of the present invention will be more apparent by describing certain embodiments of the present invention with reference to the accompanying drawings, in which:

FIG. 1 is a SEM micrograph of the surface of a plating layer resulted from high-speed copper plating (magnification: 1000×);

FIG. 2 is a graph showing a relation between pH and stability constants (Log K_{f}) of an EDTA complex;

FIG. 3 is a graph showing relations among Fe concentration in a Cu plating layer, electric resistivity and percentage elongation at fracture, in which (a) shows a relation between Fe concentration and elongation (%) at fracture, and (b) shows a relation between electric resistivity and elongation (%) at fracture;

FIG. 4 is a graph showing a relation between Fe concentration of the plating solution and the thickness of a plating layer according to the elapsed immersion time;

FIG. 5 is a SEM micrograph of organic compound powder contained in additives (magnification: 2000×);

FIG. 6 is a SEM micrograph of inorganic compound powder contained in additives (magnification: 50×);

FIG. 7 is a micrograph of the wound (taping-itself of wire) part of a wire taken by an optical microscope (magnification: 400×);

FIG. 8 is a micrograph of the straight part of a wire taken by an optical microscope (magnification: 200×);

FIG. 9 is a SEM micrograph of the plating layer of a wire (magnification: 1000×);

FIG. 10 is a SEM micrograph of the plating layer of the wire No. 1 (magnification: 1000×);

FIG. 11 is a graph illustrating the evaluation result of arc stability of a wire at high current 300 A;

FIG. 12 is a graph illustrating the evaluation result of arc stability of a wire at low current 150 A;

FIG. 13 is a micrograph of the wound (taping-itself of wire) part of the comparative example wire No. 17 taken by an optical microscope (magnification: 500×);

FIG. 14 is a micrograph of the straight part of the comparative example wire No. 24 taken by an optical microscope (magnification: 200×);

FIG. 15 is a micrograph of the wound (taping-itself of wire) part of the comparative example wire No. 24 taken by an optical microscope (magnification: 500×);

FIG. 16 is a micrograph of the wound (taping-itself of wire) part of the comparative example wire No. 30 taken by an optical microscope (magnification: 500×);

FIG. 17 is a graph illustrating arc stability of the comparative example wire No. 24 at high current 300 A; and

FIG. 18 is a graph illustrating arc stability of the comparative example wire NO. 24 at low current 150 A.

### DETAILED DESCRIPTION OF THE PREFERRED EMBODIMENTS

A preferred embodiment of the present invention will be described herein below with reference to the accompanying drawings.

The inventors realized that there were three objects to resolve for achieving high-speed copper plating:

(1) When a 5.5 mm wire rod undergoes drawing, the resulting wire of 1.4-2.5 mm in diameter for plating process has very rough surface;

(2) Additional processes should be performed such as wet drawing and surface treatment even after plating; and

(3) Alkali metals and alkaline earth metals should remain in the plating layer.

In order to resolve the above-described objects, the inventors decided to go over each process carefully.

First of all, to overcome the problem with the rough surface of the wire for use in the plating process, the inventors observed the steel-making process and processing a 5.5 mm wire rod at billets in a raw material manufacturer, and examined the surface before and after pickling which is performed to remove scales on the surface. Especially, the inventors had a research for minimizing the roughness on the surface by changing the wire drawing reduction rate of 6-12 blocks in a drawing process having the most significant influence on the characteristics of the surface. However, we reached a conclusion that it is very difficult to accomplish stable manufacturing and control the wire surface at the same time in a high-speed job.

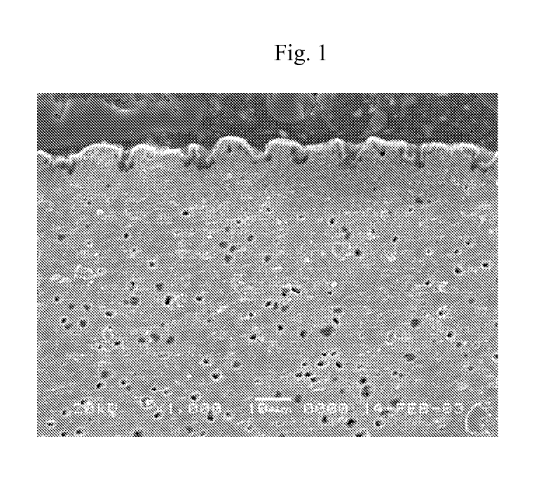

While we acknowledged that it was difficult to get a perfectly smooth surface of a wire for dry drawing and copper plating, and based on the relation between the roughness of the surface and the plating properties, we discovered that the plating adhesion properties are closely related to the bridge phenomenon. As shown in FIG. 1, the bridge phenomenon is found in a severely dented subject for plating, in which the plating precipitation rate of a protruded edge portion is faster than the plating precipitation rate at a concaved (or dent) portion so that edge portions are connected to each other like a bridge. In this case, a non-plated space is formed between the bottom surface and the plating layer, and as a way of checking plating adhesive strength (or adhesiveness) in a final wire product, a taping-itself of wire test JIS H8504 (Methods of adhesion test for metallic coatings) is carried out. Then, the bridged portion is split and the plating is fallen off. This fallen plating powder is accumulated inside the welding tip and therefore, the tip is getting clogged and feeding loads inside a welding cable are increased, deteriorating a smooth feeding performance.

This bridge phenomenon gets worse especially in a plating solution of high concentration. As copper plated solid wires for welding are sold at relatively low prices, in order to obtain a great amount of plating attachment within a short period of time, a high-concentration plating solution is more advantageous than a copper sulfate plating solution of low concentration from a viewpoint of manufacturing cost and productivity although the bridge problem needs to be resolved.

After the intensive study in a method for overcoming the bridge phenomenon that gets severe on a rough wire surface during the high-speed plating process, the inventors have discovered that the bridge phenomenon is closely related to the surface tension of the plating solution and the Cu precipitation rate.

That is, the surface tension of the plating solution should be low in order to make the plating solution penetrate into recessed portions of the wire within a short amount of time, and brings the plating precipitation reaction of the recessed portions. At the same time, it could set up an optimal condition of the plating solution composition to delay the Cu plating precipitation on the edge portion.

FIG. 1 is a SEM (Scanning Electron Microscope) micrograph of the bridge phenomenon occurred on the bottom surface of the wire and the plating layer during the high-speed copper plating process (magnification: 1000×). In the picture, a recessed portion on the surface, that is, a black portion is a non-plated portion, and a plating layer connecting edge portions (this is the bridge phenomenon) is formed thereon.

Secondly, knowing that the wet drawing and surface treatment processes are carried out after the plating process, we expected the plating layer would be damaged by the surface processing. After studying the processing degree and the shape of the plating layer before and after processing, we realized that the thickness of the plating layer should be at least greater than a certain value for smooth wire drawing. That is to say, we were not to simply reduce the surface tension of the plating solution and control the Cu precipitation on the edge portion, but to make the plating thickness equal to or greater than 0.2 μm in order to obtain a solid wire for welding with excellent arc stability without damages on the plating layer in the post process.

Thirdly, although feedability may be improved by enhancing adhesion, to attain excellent arc stability, alkali metals and alkaline earth metals should remain in the plating layer. Japanese Patent Laid-open No. 6-218574 disclosed a method for adhering some of alkali metallic salts to the surface of a wire and performing annealing. Unfortunately however, when alkali metals exist on the surface of a wire as alkali metal oxides, substitution reaction does not occur actively in the plating process, thereby deteriorating plating adhesion.

Therefore, our research has focused on a method that an alkali metal (Na) and alkaline earth metals (Mg, Ca) can remain in the Cu plating layer for substitution plating. As a result thereof, we could set an appropriate level of the concentration of Fe ions in the plating solution, and get metallic ions having greater ionization tendency than Cu ion remained in the plating solution.

As described below, alkali metals and alkaline earth metals on the left side have greater ionization tendency than others metals on the right side:

Cs>Rb>K>Na>Ba>Ce> . . . Ca>Mg>Al>Mn>Zn>Cr>Fe>Co>Cu>Au . . .

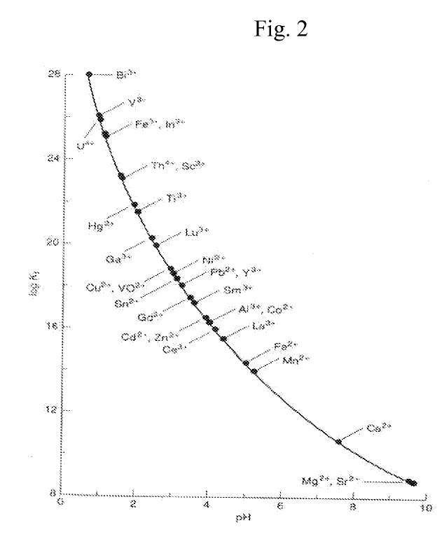

To form a complex selectively with Cu, EDTA (Ethylene Diamine Tetra Acetic acid) was used as an additive as shown in FIG. 2. EDTA is an organic substance whose degree of complex formation depending on pH range varies by metallic ions. For instance, EDTA forms a stable complex with alkaline earth metals Mg and Ca ions in an alkali range having pH 7 or greater, whereas forms a stable complex with Cu ion in a range having pH 4 or lower. Also, EDTA forms a stable complex with Fe ion in an intermediate range having pH 5.

Since the copper sulfate plating solution is kept in a range having pH 4 or lower, EDTA forms the most stable complex with Cu ion, i.e., Cu-EDTA complex, but forms an unstable complex with Fe ion.

Then, as shown in the reduction equations below, the standard reduction potential (E⁰) from 0.339V where the Cu ion is precipitated into Cu metal is lowered to −0.119V where the Cu-EDTA complex state is precipitated in the Cu metal. That is, the reducing power is increased higher than that of the Cu ion state. Thus, a rapid reduction occurs around the ion that formed a Cu-EDTA complex. Since alkali metals and alkaline earth metals that hardly formed a complex with EDTA also have the standard reduction potential lower than Cu-EDTA, Cu is precipitated and Na, Mg and Ca are also partially reduced and precipitated around the grain boundaries of Cu plating at the same time.

| | |
|---|---|
| Cu²⁺ + 2e− = Cu(s) | E⁰ = 0.339(V) |
| Cu (Ethylene diamine)²⁺ + e− = | E⁰ = −0.119(V) |
| Cu(s) + 2 Ethylene diamine | |
| Ca²⁺ + 2e− = Ca(s) | E⁰ = −2.868(V) |
| Mg²⁺ + 2e− = Mg(s) | E⁰ = −2.360(V) |
| Na⁺ + e− = Na(s) | E⁰ = −2.714(V) |

Meanwhile, although Fe ion in the plating solution forms an unstable complex with EDTA, part of ions that formed Fe-EDTA complex are reduced and precipitated with Cu in the plating layer. The increase in Fe in the plating layer not only hardens the plating layer but also increases electric resistance, thereby causing an unstable arc during welding.

Therefore, the inventors could manufacture a copper plating solid wire with excellent arc stability based on good plating adhesion by setting the plating solution to be able to optimally manage the Fe concentration for securing plating adhesion and arc stability as well as for precipitating the alkali metal (Na) and the alkaline earth metals (Mg, Ca) together with Cu in the plating layer.

The following will now describe set-up conditions for an optimal plating solution, roles of individual additives, and reasons for limiting the contents of Fe, alkali metal (Na) and alkaline earth metals (Mg, Ca) in the surface layer.

[General Conditions for Plating Solution]

The basic composition of the plating solution adopts the high-speed copper plating condition, that is, copper sulfate (CuSO₄.5H₂O) was used as a main make-up solution, and to supply the plating solution continuously a solution whose concentration is 1.5-2 times higher than the concentration of the basic composition was used as a replenishing solution.

The temperature of the plating solution was set between 30° C. and 50° C. To keep this temperature range, an indirect heating by steam or a directing heating by an electric heater may be utilized. The following table 1 shows the basic composition of the copper sulfate plating solution.

TABLE 1

| Item | CuSO₄.5H₂O | H₂SO₄ | Temperature |
|---|---|---|---|
| Composition range | 200-300 g/L | 30-50 g/L | 30-50° C. |

(Concentration of Fe Ions in Plating Solution: 10-40g/L)

The Fe ion is an optimal element for controlling the Cu precipitation because it has an almost same ion radius and similar properties as Cu, and has a role of increasing the hardness of the plating layer (copper plating layer in this case) and controlling a reaction of Cu precipitation at the same time. However, if there are too much Fe ions in the plating layer, it decreases the electric conductivity of Cu and causes an unstable arc during welding.

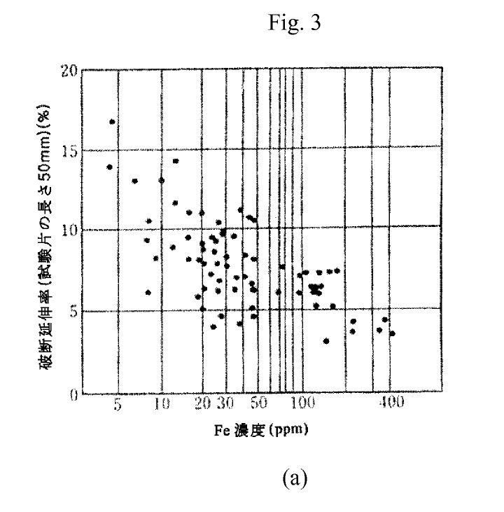

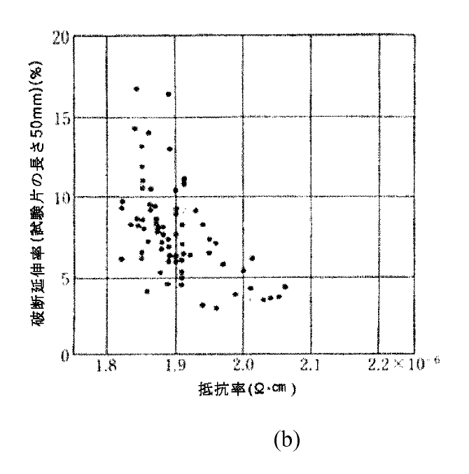

As can be seen in FIG. 3, the increase in the Fe content in the plating layer tends to harden the plating layer and substantially lower the fracture elongation and at the same time increases the electric resistivity of the Cu plating layer to resultantly lower the electric conductivity thereof. In other words, although it is better to have less amount of Fe in the plating layer from a viewpoint of the electric conductivity. However, if the amount of Fe is low, the plating layer is not hardened and feeding resistance of the solid wire for welding is increased. This is why the content of Fe in the plating layer should be managed carefully.

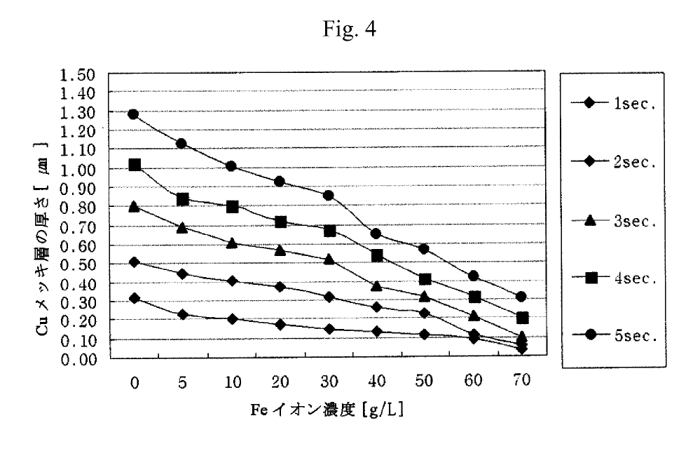

Moreover, as shown in [Table 2] and FIG. 4, as Fe ions existing in the plating solution increase, the adhesion amount of plating drops noticeably.

If the concentration of Fe ions is less than 10g/L, the precipitation rate of Cu increases sharply, but the bridge phenomenon gets severe during the plating precipitation process. In addition, if the concentration of Fe ions is greater than 40g/L, while the wire passes through a plating tank at high speed, the minimum plating thickness, 0.2 μm, required for the post process such as the wet drawing or surface treatment process is not acquired. If the plating is thinner than 0.2 μm, the bottom surface layer is exposed by the post process and this has an adverse influence on the rust resistance and the current-carrying stability (conductivity). Also, it controls the precipitation of Cu and increases the content of Fe remaining in the plating layer. Therefore, the concentration of Fe ions in the plating solution is preferably in a range of 10-40g/L.

As for replenishing Fe ions, one of industrially used (FeSO₄.7H₂O), FeCl₂, and Fe(OH)₂ may be added, or Fe metal powder may be dissolved in sulfuric acid and added later. However, since the anions combined with Fe ions increase viscosity of the plating solution and deteriorate the surface tension, the best way is to dissolve Fe metal powder in sulfuric acid and add it later. In case of adding iron chloride (FeCl₂), its amount is limited by the regulated range that is set based on the concentration of chloride ion. Meanwhile, iron hydroxide Fe(OH)₂ is not recommended either since it reacts with sulfuric acid in the plating solution and lowers pH.

TABLE 2
Concentration of Fe ions in plating solution, immersion time, change in
plating layer thickness (thickness: μm, concentration: g/L, time: sec)

| | 0 | 5 | 10 | 20 | 30 | 40 | 50 | 60 | 70 |
|---|---|---|---|---|---|---|---|---|---|
| 1 sec | 0.32 | 0.23 | 0.20 | 0.17 | 0.15 | 0.13 | 0.11 | 0.09 | 0.03 |
| 2 sec | 0.51 | 0.45 | 0.40 | 0.37 | 0.32 | 0.26 | 0.23 | 0.11 | 0.06 |
| 3 sec | 0.80 | 0.69 | 0.60 | 0.57 | 0.52 | 0.38 | 0.32 | 0.21 | 0.10 |
| 4 sec | 1.02 | 0.84 | 0.80 | 0.72 | 0.68 | 0.54 | 0.41 | 0.32 | 0.20 |
| 5 sec | 1.28 | 1.13 | 1.01 | 0.93 | 0.85 | 0.65 | 0.56 | 0.42 | 0.31 |

[Concentration of Alkali Element (Na) in Plating Solution: 0.1-1.0 g/L]

The alkali metal sodium (Na) is a metal of high ionization tendency and therefore, it is easily ionized by welding current during welding and accelerates welding performance. Especially, it increases the droplet transfer rate and contributes to the decrease of spatter.

If the concentration of Na in the plating solution is less than 0.1 g/L, which is extremely low in the plating layer, Na cannot increase the droplet transfer rate for welding. On the other hand, if the concentration of Na in the plating solution is greater than 1.0g/L, which is too much in the plating layer, an unstable arc is resulted. Also, the plating precipitation rate by the amount of anions and the amount of Na⁺ ions is decreased and this resultantly disturbs high-speed plating. Thus, a preferable range of the concentration of Na ions in the plating solution is between 0.1 g/L and 1.0g/L.

As for the addition of alkali metal Na, one of Na₂C₄H₄O₆, Na₂C₂O₄, NaCl, Na₂S₂O₄, NaHSO₄, Na₂CO₃, and KNaC₄H₄O.4H₂O, or a mixture thereof can be used according to Na conversion value.

[Concentration of Alkaline Earth Metal Ca in Plating Solution: 0.1-1.0g/L]

Alkaline earth metal calcium (Ca) improves arc stability in the arc transfer phenomenon during welding, promotes welding transfer by low ionization energy, increases the short circuit frequency of arc during welding, and reduces spatter. In the plating solution, calcium and Fe ions control the precipitation of Cu. Calcium is also partially precipitated between copper metal molecules and increases fineness (compactness) of the plating layer.

If the concentration of Ca in the plating solution is less than 0.1 g/L, which is relatively low in the plating layer, it cannot contribute to arc stability. On the other hand, if the concentration of Ca in the plating solution is greater than 1.0 g/L, similar to the effect of Fe ions, the precipitation rate of Cu is controlled and the plating layer of 0.2 μm in thickness cannot be obtained. In effect, if the amount of Ca remaining in the plating layer is increased, electric resistivity of the plating layer is increased, thereby deteriorating arc stability. Thus, a preferable range of the concentration of Ca in the plating solution is in a range between 0.1g/L and 1.0 g/L.

As for the addition of the alkaline earth metal Ca, one of inorganic compounds including CaSO₄, CaCl₂, and Ca(OH)₂, or a mixture thereof can be used according to the concentration of Ca (0.1-1.0g/L) in the plating solution.

[Concentration of Alkaline Earth Metal Mg in Plating Solution: 1.0-10g/L]

Alkaline earth metal Mg is highly reactive, and contributes to deoxidization and arc stability. Although Mg, together with Fe ions, controls the precipitation reaction of Cu to a certain extent, its main role is to improve arc stability by remaining in the plating layer.

If the concentration of Mg in the plating solution is less than 1.0g/L, which is very small in the plating layer, it cannot contribute to arc stability. On the other hand, if the concentration of Mg in the plating solution is greater than 10g/L, Mg, together with Fe ions, disturbs the precipitation of Cu, and it makes difficult to obtain the plating layer of 0.2 μm or greater in thickness for the same amount of immersion time.

Thus, a preferable concentration of Mg in the plating solution ranges between 1.0 g/L and 10 g/L, according to the Mg conversion value.

As for the addition of the alkaline earth metal Mg, one of inorganic compounds including MgSO₄, MgCl₂, MgSO₄.7H₂O, and MgCl₂.6H₂O or a mixture thereof can be used.

[Concentration of Cl in Plating Solution: 1.0-5.0 g/L]

Chloride ion in the plating solution reduces viscosity of the plating solution and lowers the surface tension thereof. Also, it gives luster to the plating layer. In general, the concentration of Cl in the plating solution ranges from 1.0 g/L to 5.0 g/L.

If the concentration of chloride ions in the plating solution is less than 1.0 g/L, the effect of surface tension is weakened and the compactness of plating is deteriorated, whereby brilliance is somewhat lost. On the other hand, if the concentration of chloride ions in the plating solution is greater than 5.0 g/L, surface tension of the plating solution is weakened while the brilliance is enhanced. However, a very small amount of Cl ions remaining on the wire surface even after going through the rinsing and neutralization processes after plating grows rusty on a final wire product.

Thus, a preferable concentration of Cl ions in the plating solution ranges between 1.0 g/L and 5.0 g/L.

As for the addition of Cl ion, one of NaCl, Epicliorohydrin (C₃H₅₀Cl), 1-Chloro-2,3-epoxypropane, NaOCl, MgCl, CaCl₂, CuCl, CuCl₂, FeCl₂, or a mixture thereof can be used according to the concentration of Cl ions in the plating solution. Here, the concentration of Cl ions is adjusted to be in a range of 1.0-5.0 g/L as aforementioned, in consideration of the concentrations of alkali metal, alkaline earth metals and Fe ions that also exist in the plating solution.

[Concentration of EDTA in Plating Solution: 0.01-0.1 g/L]

EDTA is an additive, which aids the precipitation of alkali metal and alkaline earth metals and reduces surface tension of the plating solution.

If the concentration of EDTA in the plating solution is less than 0.01 g/L, it cannot effectively reduce surface tension on the bottom surface of wires in the plating solution, and the rate of Cu-EDTA formation during the substitution reaction is lowered. As a result of this, the reduction reaction of the alkali metal (Na) and the alkaline earth metals (Mg, Ca) are not accelerated.

On the other hand, if the concentration of EDTA in the plating solution is greater than 0.1 g/L, the ratio of Cu-EDTA is increased and therefore, the precipitation rate of Cu is increased sharply, which in turn lowers the compactness of plating. In addition, it causes a relatively large amount (more than necessary) of alkali metal (Na) and alkaline earth metals (Mg, Ca) to remain in the plating layer. In consequence, arc stability during welding is deteriorated.

Thus, a preferable concentration of EDTA in the plating solution ranges between 0.01 g/L and 0.1 g/L.

For the present invention, EDTA may be added exclusively, or EDTA salts containing Ca, Na or Mg can be used also. In such case, the content of Ca, Na or Mg should be determined carefully in consideration of EDTA. If a desirable concentration of EDTA is not obtained, more EDTA is added independently.

[Addition of Additive]

An additive throughout the specification refers collectively to EDTA+Fe+Mg+Ca+Na.

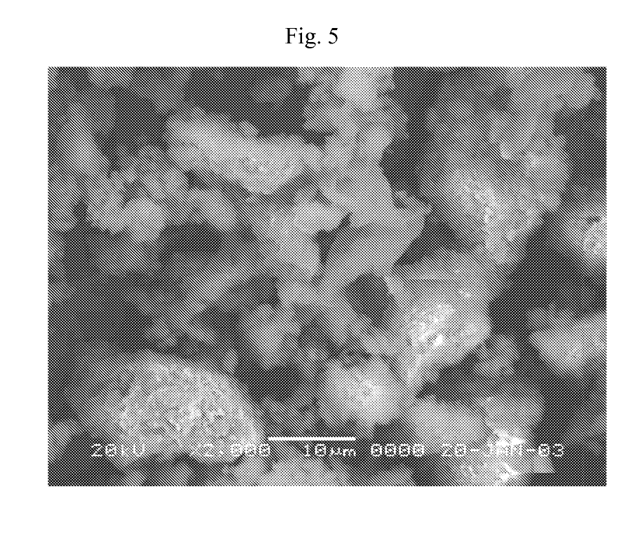

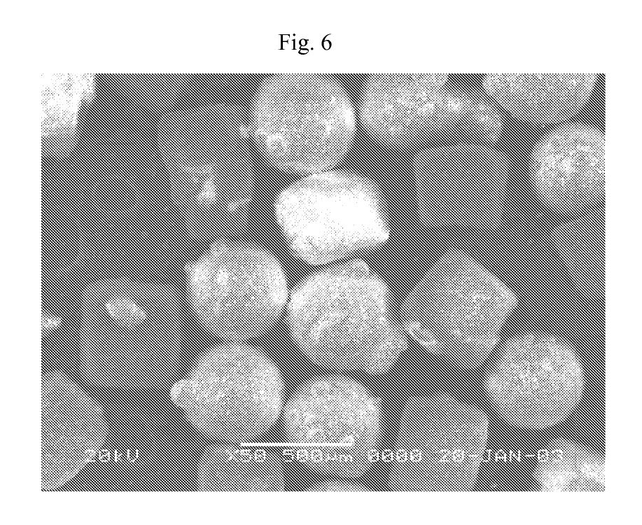

Although additives can be added individually, this is not easy to manage from a viewpoint of the plating solution management. Therefore, in the present invention, an additive was prepared in form of a mixture in consideration of the concentrations of additives and their contents. FIG. 5 is a SEM micrograph of organic compound powder obtained from additives contained in the mixture, and FIG. 6 is a SEM micrograph of inorganic compound powder in pellet obtained from additives contained in the mixture. When the additive is prepared separately, it becomes easier to input the additive or manage the concentration of the additive during the make-up bath and replenishing of the plating solution.

In view of the three problems to be solved in high-speed copper plating, the inventors set the conditions for an optimal copper plating solution as suggested in Table 3, and accomplished a copper plating solid wire with excellent feedability and arc stability.

TABLE 3
Plating solution composition conditions and effects thereof

| | Plating | Content of | Alkali + alkaline | | |
|---|---|---|---|---|---|
| | solution | elements in plating | earth | Thickness of | |
| | composition | layer (ppm) | metal (ppm) | Cu plating | Plating |
| Item | range (g/L) | Fe + Mg + Ca + Na | Mg + Ca + Na | layer (μm) | adhesion |
| CuSO₄.5H₂O | 200-300 | 100-1000 | 10-500 | 0.2-1.0 | excellent |
| H₂SO₄ | 30-50 | | | | |
| Fe | 10-40 | | | | |
| Mg | 1.0-10 | | | | |
| Na | 0.1-1.0 | | | | |
| Ca | 0.1-1.0 | | | | |
| Cl | 1.0-5.0 | | | | |
| EDTA | 0.01-0.1 | | | | |

If copper plating is conducted under the conditions suggested in the above Table 3, it becomes possible to provide a copper plating solid wire which meets the objects of the present invention as well as all of the following conditions.
1) Cu plating layer has a thickness of 0.2-1.0 m;
2) Content of microelements in the Cu plating layer: Fe+Mg+Ca +Na=100-1000 ppm; and
3) Content of alkali metal and alkaline earth metals in the Cu plating layer: Mg+Ca+Na=10-500 ppm

[Chemical Components of Wire]

The chemical component of the copper plating solid wire for welding is preferably a steel wire defined in JIS Z3312 which defines the composition of the steel wire. The following will now describe the reasons for adding its components and limiting the composition.

[Content of C: 001-0.10wt %]

Carbon is an essential element for achieving deoxidization and strength of welded metal. If the content of carbon is less than 0.01 wt %, it cannot fully influence on deoxidization and strength. On the other hand, if the content of carbon is greater than 0.10 wt %, high-temperature crack is easily formed in the welded metal. Thus, a preferable content of carbon is in a range between 0.01 wt % and 0.10 wt %.

[Content of Si: 0.3-1.0 wt %]

Si is an additive used as a deoxidizer of the welded metal. However, if the content of Si is less than 0.30 wt %, deoxidization is not fully carried out and therefore a pit or a blowhole may be formed in the welded metal. On the other hand, if the content of Si is greater than 1.0 wt %, toughness of the welded metal is deteriorated. Thus, a preferable content of Si is in a range between 0.3 wt % and 1.0 wt %.

[Content of Mn: 0.7-2.0 wt %]

Mn is an additive used for achieving deoxidization and strength of the welded metal. If the content of Mn is less than 0.7 wt %, the metal is not strong enough after deoxidization. On the other hand, if the content of Mn is greater than 2.0 wt %, a low-temperature crack may easily be formed in the welded metal. Thus, a preferable content of Mn is in a range between 0.7 wt % and 2.0 wt %.

[Content of P: 0.001-0.030 wt %]

P is an essential element for facilitating droplet transfer of a wire end for welding. However, if the content of P is less than 0.001 wt %, its effect is not sufficient. On the other hand, if the content of P is greater than 0.030 wt %, a high-temperature crack may easily be formed in the welded metal. Thus, a preferable content of P is in a range between 0.001 wt % and 0.030 wt %.

[Content of S: 0.001-0.030 wt %]

Similar to P, S is an essential element for facilitating droplet transfer of a wire end for welding. However, if the content of S is less than 0.001 wt %, its effect is not sufficient. On the other hand, if the content of S is greater than 0.030 wt %, a high-temperature crack may easily be formed in the welded metal. Thus, a preferable content of S is in a range between 0.001 wt % and 0.030 wt %.

[Content of Cu: 0.01-0.50 wt %]

Cu is an element that makes the wire conductive and provides strength to the welded metal. However, if the content of Cu is less than 0.01 wt %, it is not possible to get sufficient conductivity and strength. On the other hand, if the content of Cu is greater than 0.50 wt %, a high-temperature crack may easily be formed in the welded metal. Thus, a preferable content of Cu is in a range between 0.01 wt % and 0.50 wt %.

Although Cu may exist in the plating layer on the surface of the wire or be employed inside the steel wire, in order to improve the conductivity of the wire, Cu should be put into the plating layer on the surface of the wire by 0.01-0.50 wt %.

[Remainder: Fe and Inevitable Impurities]

Inevitable impurities include N, Mg, Ca, V, Se, Co, Zn, Sn, Te, Sr, Y, W, Pb, etc. To achieve the objects of the present invention, the content of each of the impurities should be less than 0.05 wt %, and a total content thereof should be less than 0.50 wt %. If the content of each impurity is greater than 0.05 wt %, arc stability is deteriorated or crack sensitivity is increased. Thus, a preferable content of each impurity is less than 0.05 wt % and less than 0.50 wt % in total.

[Other additives, Content of Ni: 0.01-1.0 wt %]

Ni is an additive used for improving low-temperature toughness of the welded metal. However, if the content of Ni is less than 0.01 wt %, the low-temperature toughness is not much improved. On the other hand, if the content of Ni is greater than 1.0 wt %, a high-temperature crack may easily be formed in the welded metal, and plating adhesion may be deteriorated during plating. Thus, a preferable content of Ni is in a range between 0.1 wt % and 1.0 wt %.

[Content of Cr: 0.01-0.50 wt %]

Cr is effective for improving the strength of the welded metal. However, if the content of Cr is less than 0.01 wt %, its effect is not satisfactory. On the other hand, if the content of Cr is greater than 0.50 wt %, elongation of the welded metal is lowered, plating adhesion is deteriorated during the plating process, and remaining Cr deteriorates electric conductivity of the plating layer. Thus, a preferable content of Cr is in a range between 0.01 wt % and 0.50 wt %.

[Content of Mo: 0.01-0.50 wt %]

Mo is effective for improving low-temperature toughness and strength of the welded metal. However, if the content of Mo is less than 0.01 wt %, its effect is not obvious. On the other hand, if the content of Mo is greater than 0.50 wt %, a high-temperature crack may easily be formed in the welded metal, plating adhesion is deteriorated during the plating process, and remaining Mo deteriorates electric conductivity of the plating layer. Thus, a preferable content of Mo is in a range between 0.01 wt % and 0.50 wt %.

[Content of Al: 0.01-0.50 wt %]

Al is effective for deoxidization of the welded metal and welding bead formation. However, if the content of Al is less than 0.01 wt %, the deoxidization reaction is not strong enough and therefore, it becomes impossible to adjust the configuration of a welding bead. On the other hand, if the content of Al is greater than 0.50 wt %, a high-temperature crack may easily be formed in the welded metal, plating adhesion is deteriorated during the plating process, and remaining Al deteriorates electric conductivity of the plating layer. Thus, a preferable content of Al is in a range between 0.01 wt % and 0.50 wt %.

[Content of Ti+Zr: 0.01-0.30 wt %]

Ti and Zr aid deoxidization of the welded metal and reduces welding spatter. If desired, Ti can be added alone. If the content of Ti and Zr is less than 0.01 wt %, the effect of spatter reduction is not satisfactory and the deoxidization reaction is not strong enough. On the other hand, if the content of Ti and Zr is greater than 0.30 wt %, a high-temperature crack may easily be formed in the welded metal. Thus, a preferable content of Ti and Zr is in a range between 0.01 wt % and 0.30 wt %.

[Method of Adhesion Test for Plating Layer]

The most typical method of adhesion test among other plating qualities is JIS H8504 (Methods of adhesion test for metallic coatings). The easiest way is a taping-itself of wire test. In detail, when a wire is wound several times around a hand reel axis or the wire itself, one is to observe using an optical microscope whether the plating layer formed on the surface of the wire is cracked or peeled off. The stronger the plating adhesive strength of the wire is, the less the crack or peeling off of the plating layer occurs. This is important because it is directly related to wire feedability.

[Quantitative Determination of Microelements in Plating Layer]

[Preparation Method of Peeling Solution of Plating Layer]

The peeling solution of the plating layer was prepared by dissolving 25 g of CCl₃COOH into 300 ml of ammonia (NH₄OH) in a flask and pouring distilled water in the flask up to 1000 ml.

[Sample Pretreatment for Analysis of Microelements in Plating Layer]

About 25 g of a wire was cut to 2-5 cm and put in a 250 ml beaker containing CCl₄ or ethyl alcohol (CH₃CH₂OH). The mixture was then put in an ultrasonic washer, which performs removal of fat (grease), for 10 minutes and as a result, feeding oil and anti corrosive oil attached to the surface of the wire were completely removed. After the wire is completely washed, it was put into a dry oven of 105° C. for 10 minutes until the surface of the wire is completely dried. Then, the wire was placed in a desiccator and cooled to room temperature.

This cooled wire was weighed (W1) to four decimal points using a balance, and placed in a 250 ml beaker. Then, 25 ml of the plating peeling solution was poured into the beaker. After covering the beaker with a glass dish like watch cover, the reaction was continued at room temperature for 20 minutes.

20 minutes later, the plating peeling solution was poured into a different beaker, and the wire was washed under flowing clean water. The wire was immersed in ethyl alcohol (CH₃CH₂OH) and dried in a dry oven of 105° C. for 10 minutes. Later, it was placed in a desiccator and cooled to room temperature. The cooled wire was weighed again (W2), and the difference between the first weight (W1) and the second weight (W2) was set as the weight of plating.

The plating peeling solution in the beaker was covered with a glass dish and volatilized and dried out in a heat bath with sand of 200-300° C. until the amount of the solution is reduced to 5 ml. Then, it was mixed with 5 ml of nitric acid (HNO₃) and 1 ml of hydrochloric acid (HCl) and heated on a hot plate for 1 minute to dissolve soluble components therein. The mixture was cooled to room temperature. The glass dish and the inner wall of the beaker were cleansed with distilled water, while the mixture was put into a 100 ml flask and distilled water was poured therein up to 100 ml to be used as the sample for analysis.

[Blank Test]

Blank test is done for measuring and correcting the amounts of Fe, Mg, Ca and Na existing in the plating peeling solution. The above-described sample pretreatment was used, except that the wire was not put into the 100 ml flask where distilled water was poured up to the standard line of the 100 ml flask to get a blank sample.

[Quantitative Determination of Microelements]

Measurement of a sample for analysis was done by utilizing an IRIS Advantage device manufactured by Thermo Elemental Company as ICP-AES (Inductively Coupled Plasma Atomic Emission Spectrometer).

[Method of Drawing Calibration Curve for ICP Measurement]

The calibration curve for ICP measurement was drawn based on the standard substance addition method. To form the same matrix with a sample for measuring, four samples that went through the above-described sample pretreatment were put into 100 ml flasks, respectively, and Ca, Na, Mg and Fe standard solutions were poured thereto by blank, 0.5 ppm, 1 ppm, and 10 ppm, respectively, to prepare the standard solutions for drawing the calibration curve.

The conditions for the measurement equipment are described in Table 4 below. An average of five measurements was selected, and relative standard deviation (RSD) of individual elements was set below 2%.

TABLE 4
Measurement conditions of ICP equipment

| | | | | Sample introduction system/Torches | | | |
|---|---|---|---|---|---|---|---|
| | | Coolant | Auxiliary | Peristaltic | | | |
| | Plasma | flow | flow | PUMP | Spray | | |
| Element | (W) | (L/min) | (L/min) | tubing | chamber | Nebulizer | Torch |
| Mg, Ca, Na | 750 | 40 | 1.0 | 100 rpm | Cyclon | Concentric | Quartz |
| Fe | 1150 | 40 | 1.0 | 100 rpm | Cyclon | Concentric | Quartz |

[Method for Measuring Thickness of Cu Plating Layer]

The thickness of the plating layer was measured by using CT-2, the destructive electrolytic plating thickness measuring device, manufactured by Elec Fine Instruments Co., Ltd. The reason for using the destructive plating layer thickness measuring device is because it is possible to double check through an optical microscope whether or not the plating layer is removed.

Besides the above measuring device, there are non-destructive thickness measuring devices, such as, X-ray plating thickness measurement, β-ray plating thickness measurement, eddy current system, and electronic plating thickness measuring device. These devices can also be used for measurement.

[Principle of Electrolytic Plating Thickness Measuring Device]

After immersing the plating layer in a reagent that reacts on Cu, a current is applied thereto to melt the plating layer. The electrolytic plating thickness measuring device continuously senses an electric potential difference between the plating layer and the bottom layer of wire, and converts the electric potential difference generated when the plating layer is electrolyzed into the plating thickness measurement unit and displays the result.

[Conversion of Cu Plating Thickness by Gravimetric Determination]

When the plating thickness is measured without using a device, the above-described plating peeling solution is used. In detail, a gravimetric difference before and after removing the plating layer is converted to the plating layer thickness (μm) using Equation 1 below.

[Equation 1]
Thickness of Cu (μm)={(W1−W2)/4*W2}*D*(Specific gravity of Fe/Specific gravity of Cu)*1000
(Here, W1 is the weight (g) of a wire before its plating is peeled off, W2 is the weight (g) of a wire after its plating is peeled off, D is a wire diameter (mm), specific gravity of Fe is 7.86 g/cm³, and specific gravity of Cu is 8.93 g/cm³.

[Example]

A wire used in the present invention is a wire of JIS Z3312, and the analysis result of its main ingredients is shown in Table 5. For the analysis, two rods of at least 5.5 mm in diameter having the chemical components suggested in Table 5 went through pickling, Bonderite, and Borax coating, and drawn from 1.5 mm to 2.5 mm in diameter. Then, the wires went through NaOH electrolytic degreasing line and were pickled with the sulfuric acid in the electrolytic solution condition.

TABLE 5
Analysis result of chemical components of wire

| | Wire | Chemical components of wire (wt %) | | | | | | | | | | |
|---|---|---|---|---|---|---|---|---|---|---|---|---|
| | No. | C | Si | Mn | P | S | Cu | Ni | Cr | Mo | Al | Ti + Zr |
| Ex. | 1 | 0.06 | 0.85 | 1.50 | 0.014 | 0.012 | 0.18 | 0.01 | 0.04 | 0.01 | 0.003 | 0.004 |
| | 2 | 0.05 | 0.88 | 1.52 | 0.012 | 0.006 | 0.25 | 0.02 | 0.03 | 0.01 | 0.012 | 0.19 |
| | 3 | 0.07 | 0.52 | 1.12 | 0.015 | 0.014 | 0.22 | 0.01 | 0.02 | 0.01 | 0.004 | 0.002 |
| | 4 | 0.09 | 0.65 | 1.95 | 0.015 | 0.010 | 0.16 | 0.01 | 0.03 | 0.45 | 0.004 | 0.005 |
| | 5 | 0.05 | 0.86 | 1.50 | 0.018 | 0.009 | 0.19 | 0.02 | 0.04 | 0.01 | — | — |
| | 6 | 0.07 | 0.90 | 1.90 | 0.019 | 0.012 | 0.23 | 0.01 | 0.04 | — | 0.004 | 0.17 |
| | 7 | 0.06 | 0.53 | 1.15 | 0.014 | 0.007 | 0.15 | 0.01 | 0.03 | 0.01 | 0.085 | 0.11 |
| | 8 | 0.08 | 0.92 | 1.92 | 0.015 | 0.007 | 0.18 | 0.02 | 0.02 | 0.01 | 0.005 | 0.19 |
| | 9 | 0.05 | 0.64 | 1.98 | 0.013 | 0.012 | 0.20 | 0.02 | 0.04 | 0.38 | 0.007 | 0.19 |
| | 10 | 0.04 | 0.50 | 1.11 | 0.007 | 0.007 | 0.28 | 0.01 | 0.02 | 0.01 | 0.086 | 0.17 |
| | 11 | 0.09 | 0.90 | 1.98 | 0.017 | 0.010 | 0.29 | 0.02 | 0.03 | 0.35 | 0.008 | 0.20 |
| | 12 | 0.04 | 0.92 | 1.45 | 0.012 | 0.011 | 0.17 | 0.01 | 0.04 | 0.01 | 0.003 | 0.005 |
| | 13 | 0.06 | 0.79 | 1.55 | 0.018 | 0.015 | 0.26 | 0.01 | 0.02 | 0.01 | 0.008 | 0.11 |
| | 14 | 0.05 | 0.45 | 0.95 | 0.014 | 0.013 | 0.24 | 0.02 | 0.02 | 0.01 | — | — |
| | 15 | 0.11 | 0.52 | 1.20 | 0.016 | 0.015 | 0.16 | 0.01 | 0.02 | 0.01 | 0.02 | 0.16 |
| Ce. | 16 | 0.06 | 0.85 | 1.50 | 0.014 | 0.012 | 0.18 | 0.01 | 0.04 | 0.01 | 0.003 | 0.004 |
| | 17 | 0.05 | 0.88 | 1.52 | 0.012 | 0.006 | 0.25 | 0.02 | 0.03 | 0.01 | 0.012 | 0.19 |
| | 18 | 0.07 | 0.52 | 1.12 | 0.015 | 0.014 | 0.22 | 0.01 | 0.02 | 0.01 | 0.004 | 0.002 |
| | 19 | 0.09 | 0.65 | 1.95 | 0.015 | 0.010 | 0.16 | 0.01 | 0.03 | 0.45 | 0.004 | 0.005 |
| | 20 | 0.05 | 0.86 | 1.50 | 0.018 | 0.009 | 0.19 | 0.02 | 0.04 | 0.01 | — | — |
| | 21 | 0.07 | 0.90 | 1.90 | 0.019 | 0.012 | 0.23 | 0.01 | 0.04 | — | 0.004 | 0.17 |
| | 22 | 0.06 | 0.53 | 1.15 | 0.014 | 0.007 | 0.15 | 0.01 | 0.03 | 0.01 | 0.085 | 0.11 |
| | 23 | 0.08 | 0.92 | 1.92 | 0.015 | 0.007 | 0.18 | 0.02 | 0.02 | 0.01 | 0.005 | 0.19 |
| | 24 | 0.05 | 0.64 | 1.98 | 0.013 | 0.012 | 0.20 | 0.02 | 0.04 | 0.38 | 0.007 | 0.19 |
| | 25 | 0.04 | 0.50 | 1.11 | 0.007 | 0.007 | 0.28 | 0.01 | 0.02 | 0.01 | 0.086 | 0.17 |
| | 26 | 0.09 | 0.90 | 1.98 | 0.017 | 0.010 | 0.29 | 0.02 | 0.03 | 0.35 | 0.008 | 0.20 |
| | 27 | 0.04 | 0.92 | 1.45 | 0.012 | 0.011 | 0.17 | 0.01 | 0.04 | 0.01 | 0.003 | 0.005 |
| | 28 | 0.06 | 0.79 | 1.55 | 0.018 | 0.015 | 0.26 | 0.01 | 0.02 | 0.01 | 0.008 | 0.11 |
| | 29 | 0.05 | 0.45 | 0.95 | 0.014 | 0.013 | 0.24 | 0.02 | 0.02 | 0.01 | — | — |
| | 30 | 0.11 | 0.52 | 1.20 | 0.016 | 0.015 | 0.16 | 0.01 | 0.02 | 0.01 | 0.02 | 0.16 |

Ex.: Example,
Ce.: Comparative example

[Performing Cu Plating]

To manufacture a wire for the example, the wire was immersed for 1.5-2.5 seconds in a plating tub under the conditions for the plating solution composition suggested in the Table 3, and went through a rinsing tub. Then, the wire was drawn to 1.2 mm using a lubricant.

The comparative example was manufactured by the same method in a make-up plating solution in the out of ranges of the conditions for the plating solution composition.

[Plating Adhesive Strength Test]

The plating adhesive strength (or adhesiveness) in a final wire product was checked by a taping-itself of wire test JIS H8504 (Methods of adhesion test for metallic coatings) using an optimal microscope (400-500×) to a measure of peeling off the plating.

[Arc Stability Test]

As for a method for testing arc stability of a wire during welding, the wires described in the Table 5 were manufactured as shown in Table 10, and a continuous automatic welding was performed thereon for 180 seconds in a low-current area and in a high-current area, respectively, under the welding conditions defined in Table 6 below. The wires were monitored 5000 times per second using an arc monitoring system WAM4000D Ver2.0. In the low-current area which is a short circuit area, the arc stability was tested at an instantaneous short circuit rate. Meanwhile, in the high-current area which is a globular transfer section, the arc stability was tested based on the test standards suggested in Table 7 below with the standard deviation of a welding current. From the low-current area, a fine bead appearance having low-spatter generation was obtained when the instantaneous short circuit rate is less than 5%. From the high-current area, a fine bead appearance having minimum-spatter generation was obtained when the standard deviation of the welding current is less than 10. An original test piece used for welding was prepared by grinding SS400 25t material and completely removing scales thereon.

TABLE 6
Welding monitoring conditions for arc stability test

| Wire | | Welding | Welding | Shielding | | Welding | Torch |
|---|---|---|---|---|---|---|---|
| diameter | Polarity | current | voltage | gas | Gas flow | speed | height(CTWD) |
| 1.2 mm | DC-EP | 150/300 A | 25/32 V | CO₂ 100% | 29 L/min | 40 CPM | 15-20 mm |

TABLE 7
Arc stability test standards

| | | | Low-current | High-current | |
|---|---|---|---|---|---|
| | | | (150 A) | (300 A) | |
| | | | Instantaneous | | |
| | Monitoring | | short circuit | SD of welding | |
| Item symbol | time (sec) | Arc stoppage | rate* | current | Results |
| ◯ | 180 | None | Less than 5% | Less than 10 | Good |
| Δ | 180 | Once and less | 5-10% | 10-50 | Fair |
| X | 180 | Twice or more | Greater than | Greater than | Poor |
| | | | 10% | 50 | |

*Instantaneous short circuit rate (%) = instantaneous short circuit frequency/total short circuit frequency * 100

[Wire Feedability Test]

Wire feedability indicates whether a solid wire is fed from a welding tip at a constant speed. If feedability is poor, wires are not smoothly supplied from the welding tip. In this case, welding arc length is longer and thus, the arc becomes unstable or stops instantly. And, a wire with excellent feedability means that wires are smoothly supplied without arc stoppage even although the shape of a welding cable has W, 1 turn and 2 turns. In the present invention, continuous welding was performed on a 5 m welding cable under the welding conditions described in Table 8. And, a welding wire went through the feedability test based on the test standards suggested in Table 9, under the shapes of W, 1 turn and 2 turns of welding cable with conditions of radius, r=150 mm and diameter, d=300 mm, respectively.

TABLE 8
Wire feedability test welding conditions

| Welding | Welding | Shielding | | Welding | Length of |
|---|---|---|---|---|---|
| current | voltage | gas | Gas flow | time | cable |
| 300 A | 34 V | CO₂ 100% | 20 L/min | — | 5 m |

TABLE 9
Wire feedability test standards

Welding cable conditions

| Item No. | W | 1 turn | 2 turns | Results |
|---|---|---|---|---|
| ◯ | Possible | Possible | Possible | Good |
| Δ | Possible | Possible | Impossible | Fair |
| X | Possible | Impossible | Impossible | Poor |

Among the test standards, ‘possible’ means that continuous welding is possible for at least 50 seconds under respective welding cable conditions, and ‘impossible’ means that an arc stoppage has occurred less than 50 seconds under respective welding cable conditions.

TABLE 10

| | | | | | | | | | Alkali** | | |
|---|---|---|---|---|---|---|---|---|---|---|---|
| | | | | | | | Plating | | alkaline | | |
| | | Content of microelement in | | | | | layer | Total | earth | Welding property tests | |
| | Wire | plating layer (ppm) | | | | | thickness | content* | metal | | Arc |
| | No. | Cu | Fe | Na | Ca | Mg | (μm) | (ppm) | (ppm) | Feedability | stability |
| Ex. | 1 | Bal. | 92 | 210 | 20 | 10 | 0.75 | 332 | 240 | Δ | ◯ |
| | 2 | Bal. | 90 | 120 | 80 | 2 | 0.65 | 292 | 202 | Δ | ◯ |
| | 3 | Bal. | 160 | 280 | 80 | 5 | 0.55 | 525 | 365 | ◯ | ◯ |
| | 4 | Bal. | 250 | 320 | 70 | 8 | 0.46 | 648 | 398 | ◯ | Δ |
| | 5 | Bal. | 320 | 250 | 90 | 1 | 0.42 | 661 | 341 | ◯ | ◯ |
| | 6 | Bal. | 340 | 120 | 100 | 1 | 0.31 | 561 | 221 | ◯ | ◯ |
| | 7 | Bal. | 410 | 240 | 105 | 12 | 0.28 | 767 | 357 | ◯ | ◯ |
| | 8 | Bal. | 460 | 120 | 130 | 5 | 0.39 | 715 | 255 | ◯ | ◯ |
| | 9 | Bal. | 510 | 70 | 30 | 2 | 0.34 | 612 | 102 | ◯ | ◯ |
| | 10 | Bal. | 560 | 50 | 70 | 12 | 0.34 | 692 | 132 | ◯ | ◯ |
| | 11 | Bal. | 630 | 130 | 50 | 7 | 0.28 | 817 | 187 | ◯ | ◯ |
| | 12 | Bal. | 670 | 120 | 30 | 50 | 0.24 | 870 | 200 | ◯ | ◯ |
| | 13 | Bal. | 720 | 120 | 21 | 26 | 0.22 | 887 | 167 | ◯ | ◯ |
| | 14 | Bal. | 930 | 25 | 2 | 7 | 0.21 | 964 | 34 | ◯ | Δ |
| | 15 | Bal. | 800 | 20 | 10 | 1 | 0.23 | 831 | 31 | ◯ | Δ |
| Ce. | 16 | Bal. | 41 | 320 | 410 | 50 | 0.32 | 821 | 780 | Δ | X |
| | 17 | Bal. | 10 | 12 | 5 | 4 | 1.52 | 31 | 21 | X | X |
| | 18 | Bal. | 20 | 50 | 10 | 10 | 1.21 | 90 | 70 | X | Δ |
| | 19 | Bal. | 250 | 320 | 120 | 150 | 0.24 | 840 | 590 | Δ | X |
| | 20 | Bal. | 780 | 250 | 90 | 0 | 0.18 | 1120 | 340 | Δ | X |
| | 21 | Bal. | 920 | 120 | 100 | 1 | 0.17 | 1141 | 221 | Δ | X |
| | 22 | Bal. | 1120 | 25 | 10 | 2 | 0.19 | 1157 | 37 | Δ | X |
| | 23 | Bal. | 2500 | 290 | 80 | 25 | 0.12 | 2895 | 395 | Δ | X |
| | 24 | Bal. | 3500 | 70 | 30 | 0 | 0.09 | 3600 | 100 | Δ | X |
| | 25 | Bal. | 1200 | 50 | 56 | 42 | 0.15 | 1348 | 148 | Δ | X |
| | 26 | Bal. | 630 | 130 | 130 | 420 | 0.19 | 1310 | 680 | Δ | X |
| | 27 | Bal. | 670 | 450 | 140 | 250 | 0.18 | 1510 | 840 | Δ | X |
| | 28 | Bal. | 1300 | 800 | 280 | 410 | 0.12 | 2790 | 1490 | Δ | X |
| | 29 | Bal. | 40 | 360 | 260 | 120 | 0.40 | 780 | 740 | Δ | X |
| | 30 | Bal. | 350 | 5 | 2 | 0 | 0.45 | 357 | 7 | Δ | X |

Feedability and arc stability test symbol: ◯: Good, Δ: Fair, X: Poor
*Fe + Mg + Ca + Na
**Mg + Ca + Na

[Description of Example]

As shown in the example in the Table 10 of the present invention, the copper plating wire demonstrated excellent feedability and arc stability when the thickness of the plating layer was in a range of 0.2-1.0 μm, the total content of alkali metal (Na) including Fe and alkaline earth metals (Mg, Ca) in the plating layer was in a range of 100-1000 ppm, and the total content of alkali metal (Na) and alkaline earth metals (Mg, Ca) except for Fe in the plating layer was in a range of 10-500 ppm.

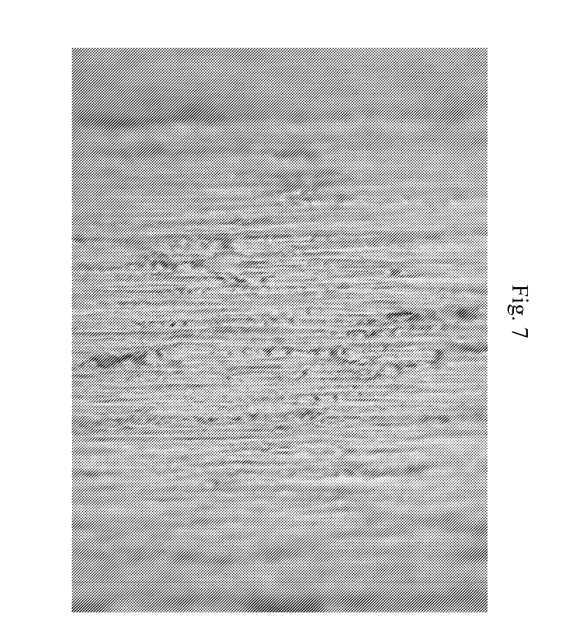

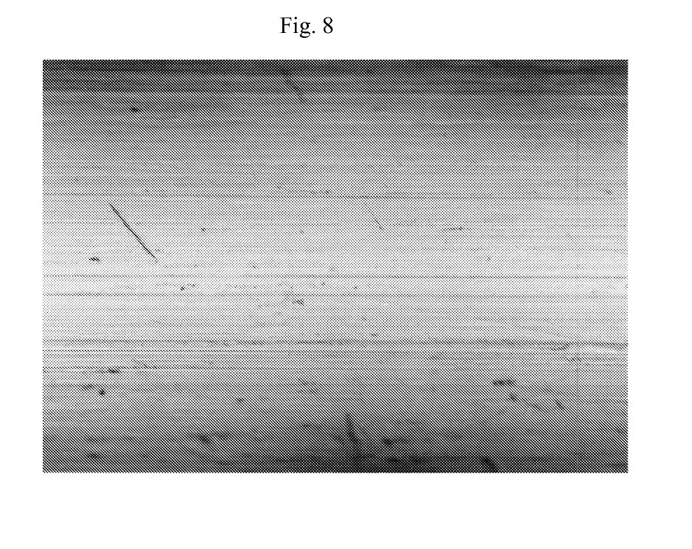

In addition, when the product wire went through the taping-itself of wire test and was observed by an optical microscope as in FIG. 7, the wire of this example showed excellent plating adhesiveness without falling off the plating layer. Also, when the straight surface of the product wire was observed by an optical microscope as in FIG. 8, the surface exposure under plating layer or non-plated portion was not observed. This proves that the surface was sufficiently protected by the 0.2-1.0 μm thick plating layer.

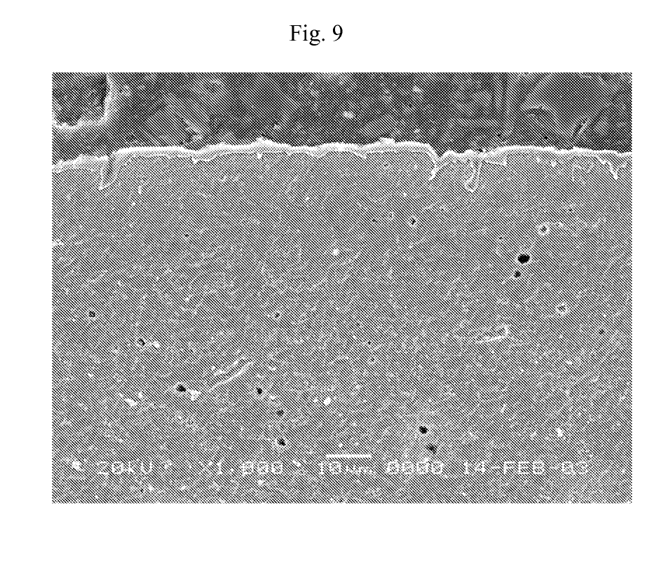

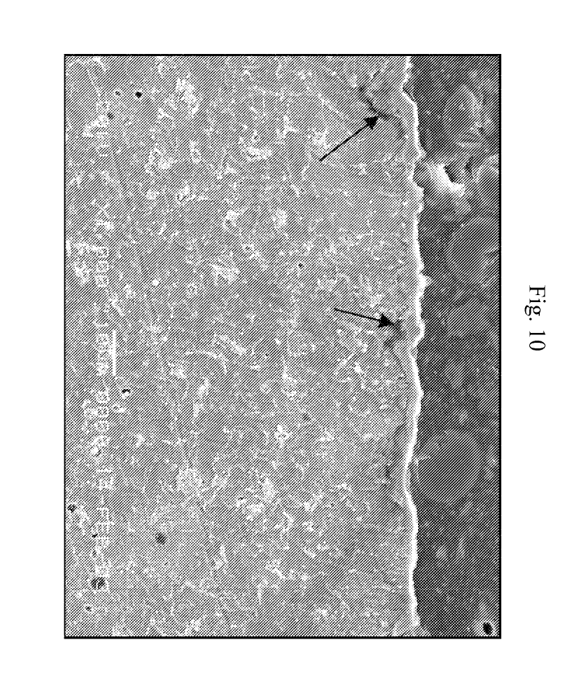

And, when the cross section of the plating layer was seen through a SEM, the bridge phenomenon was not observed in most of the wires as in FIG. 9. Meanwhile, as in the example wire Nos. 1 and 2, if the total content of the alkali metal (Na) including Fe and alkaline earth metals (Mg, Ca) in the plating layer is less than the limit suggested in the present invention, one can check through the SEM that the plaiting layer is thick and the bridge phenomenon may occur in a small portion (indicated by an arrow) as shown in FIG. 10.

However, this does not necessarily influence the plating adhesiveness and feedability. As long as the content of the alkali metal (Na) and the alkaline earth metals (Mg, Ca) is appropriate, excellent arc stability can be obtained.

Also, arc stability of the wire of this example was tested using an arc monitoring device under the low current 150 A and the high current 300 A, respectively. The test result shows that excellent arc stability based on excellent feedability was obtained in both low current and high current areas.

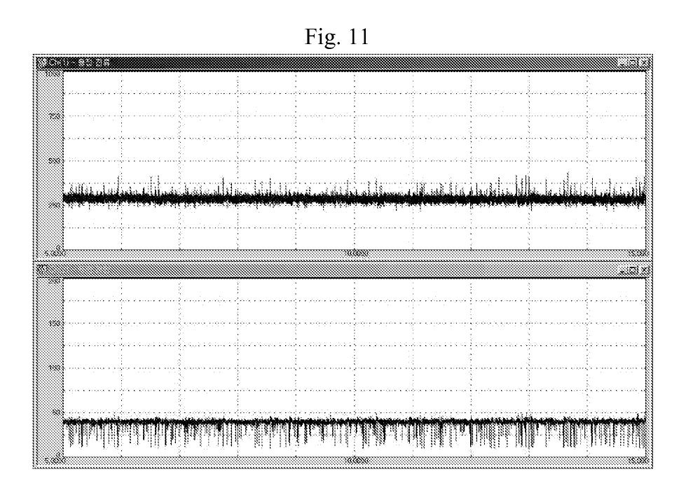

FIG. 11 is a graph illustrating the evaluation result of arc stability of the wire at high current 300 A, in which the welding current is not much changed and the arc is stable.

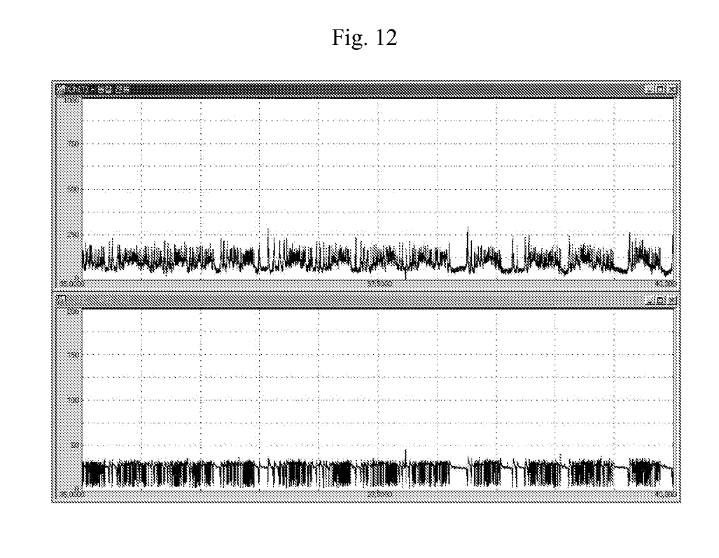

FIG. 12 is a graph illustrating the evaluation result of arc stability of the wire at low current 150 A, in which excellent arc stability is obtained without the arc stoppage.

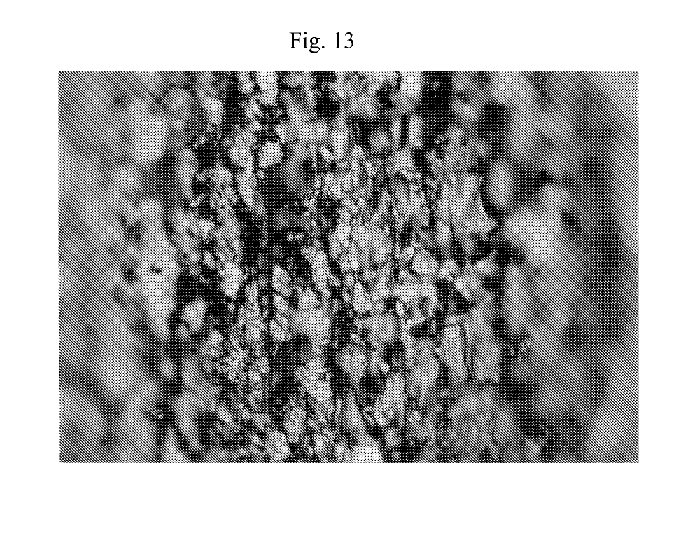

As for the comparative examples, in case of the wire Nos. 17 and 18, the total content of the alkali metal (Na) including Fe and alkaline earth metals (Mg, Ca) is less than 100 ppm. In this case, the thickness of the plating layer exceeds 1.0 μm in both cases due to the excess precipitation reaction of Cu and therefore, feedability is deteriorated substantially and the arc becomes unstable at the same time. If its product wire undergoes the taping-itself of wire test and is observed through an optical microscope as in FIG. 13, one can easily see that the adhesive strength between the bottom portion and the plating layer is not so good that the plating layer can easily be fallen off. When this occurs, the separated plating is accumulated in the tip and interrupts the continuous welding, thereby deteriorating feedability. As a result, arc stability is also deteriorated during welding.

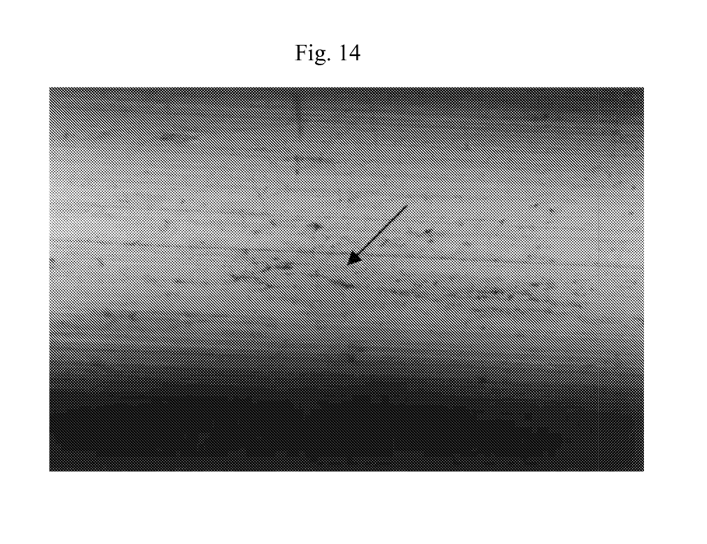

In case of the wire Nos. 20 through 28, if the total content of the alkali metal (Na) including Fe and alkaline earth metals (Mg, Ca) is greater than 1000 ppm, the Cu precipitation reaction of the plating layer during the plating process is extremely limited and thus, the plating layer cannot be thicker than 0.2 μm. Although the wire feedability may be fair, the bottom portion of wire gets exposed because of the thin plating layer as shown in FIG. 14. Therefore, when the welding tip and the non-plated layer of the product surface come in contact, arc may become unstable momentarily. In addition, arc stability is not much improved even though the total content of the alkali metal (Na) and the alkaline earth metals (Mg, Ca) is in a range of 10-500 ppm.

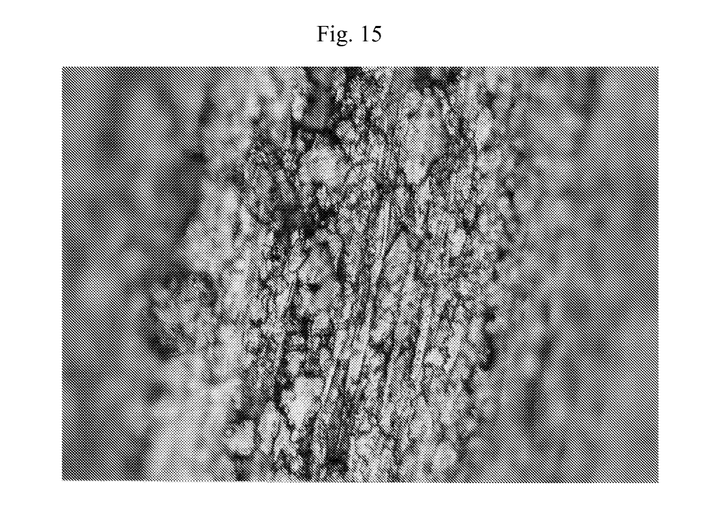

As shown in FIG. 15, the non-plated portion can be observed partially even when the taping-itself of wire test is performed thereon. As in the comparative example wire No. 30, although the plating thickness is 0.45 μm and the total content of the alkali metal (Na) including Fe and the alkaline earth metals (Mg, Ca) in the plating layer is in a range of 100-1000 ppm, the content of the alkali metal (Na) and the alkaline earth metals (Mg, Ca) excluding Fe is less than 10 ppm, meaning that arc stability is not improved in this case.

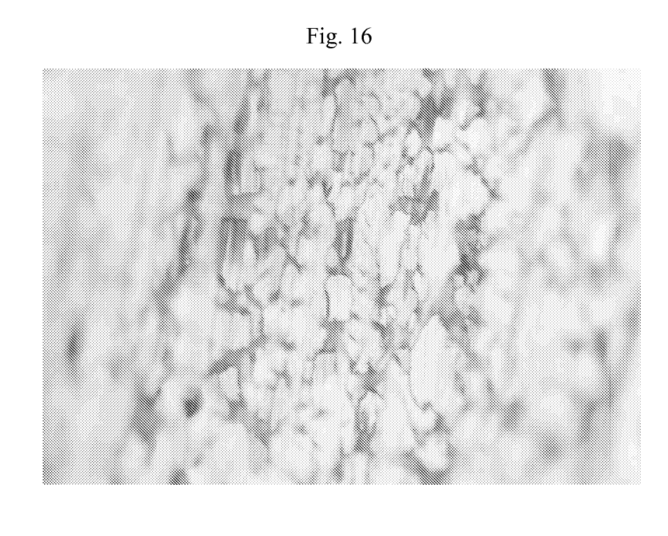

FIG. 16 is a micrograph of the comparative example wire No. 30 observed by an optical microscope after carrying out the taping-itself of wire test thereon. Unlike other comparative example wires, the wire No. 30 contained a proper amount of the alkali metal including Fe and the alkaline earth metals, which resulted in the improved plating adhesiveness. However, because the amount of the alkali metal and the alkaline earth metals in the plating layer did not meet the requirement, arc stability was poor compared with the example of the present invention.

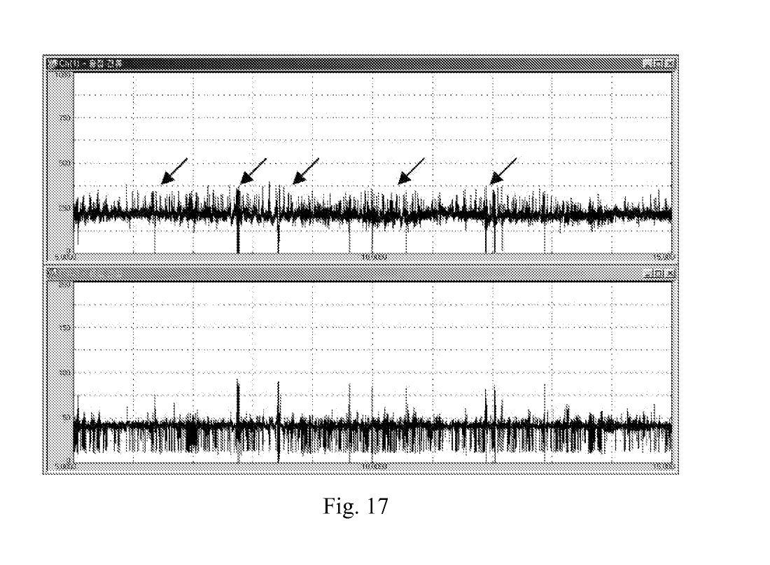

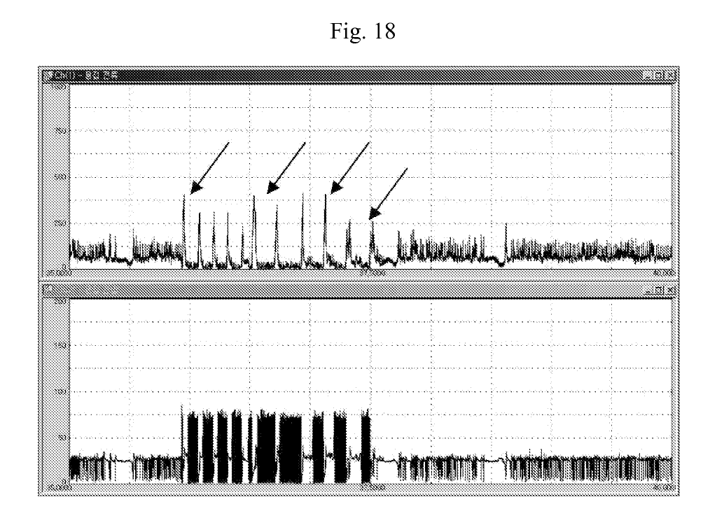

In case of the comparative example wires, wire feedability was deteriorated because of the low plating adhesiveness. And, a sufficient plating thickness could not be obtained because the alkali metal (Na) including Fe and the alkaline earth metals (Mg, Ca) in the plating layer were not properly managed. At the same time, as shown in FIG. 17 and FIG. 18, an unstable arc was generated during welding and arc stoppage or instantaneous short circuit of the arc during welding was caused, deteriorating welding quality.

FIG. 17 is a graph illustrating a welding current waveform of the comparative example wire No. 24 at high current 300 A, which is monitored by an arc monitoring device. As shown in the graph, instantaneous short-circuit (indicated by an arrow) is present and the standard deviation of the overall welding current is large.

FIG. 18 is a graph illustrating a welding current waveform of the comparative example wire NO. 24 at low current 150 A, which is monitored by an arc monitoring device. As shown in the graph, an arc is unstable (indicated by an arrow) and thus, the arc blackout phenomenon occurs.

Therefore, excellent arc stability is obtained depending on good feedability, and it becomes possible to manufacture the copper plating solid wire with excellent arc stability through copper plating.

According to the present invention, adhesiveness of the copper plating layer can be improved by setting the specific range of the content of microelements including alkali metal and alkaline earth metals in the plating solution and the plating layer, and by managing the plating thickness in the predetermined range. In this manner, it becomes possible to obtain the copper plating solid wire for MAG welding, which satisfies excellent feedability and arc stability during welding, even under high-speed plating process.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A copper plating solid wire for MAG welding with excellent arc stability during welding, in which a copper plating layer of 0.2-1.0 μm in thickness is formed on a solid wire for MAG welding composed of 0.01-0.10 wt % of C, 0.3-1.0 wt % of Si, 0.7-2.0 wt % of Mn, 0.001-0.030 wt % of P, 0.001-0.030 wt % of S, 0.01-0.50 wt % of Cu, the remainders Fe and inevitable impurities, the total content of Fe, an alkali metal (Na), and alkaline earth metals (Mg, Ca) in the copper plating layer ranges from 100 ppm to 1000 ppm, and the total content of the alkali metal (Na) and the alkaline earth metals (Mg, Ca) ranges from 10 ppm to 500 ppm at the same time.

2. The solid wire according to claim 1, wherein a solution for use in the copper plating consists of 200-300 g/L of CuSO₄.5H₂O, 30-50 g/L of H₂SO₄, 10-40 g/L of Fe, 1.0-10 g/L of Mg, 0.1-1.0 g/L of Na, 0.1-1.0 g/L of Ca, 1.0-5.0 g/L of Cl, and 0.01-0.1 g/L of EDTA.

3. A method for manufacturing a copper plating solid wire for MAG welding with excellent arc stability for plating, the method comprising the step of: immersing a solid wire for MAG welding composed of 0.01-0.10 wt % of C, 0.3-1.0 wt % of Si, 0.7-2.0 wt % of Mn, 0.001-0.030 wt % of P, 0.001-0.030 wt % of S, 0.01-0.50 wt % of Cu, the remainders Fe and inevitable impurities in a copper plating solution containing 200-300 g/L of CuSO₄.5H₂O, 30-50 g/L of H₂SO₄, 10-40 g/L of Fe, 1.0-10 g/L of Mg, 0.1-11.0 g/L of Na, 0.1-1.0 g/L of Ca, 1.0-5.0 g/L of Cl, and 0.01-0.1 g/L of EDTA at 30-50° C. for 1.5-2.5 seconds.
